(19) United States
(12) Patent Application Publication
(10) Pub. No.: US 2012/0006666 A1
(43) Pub. Date: Jan. 12, 2012

(54) KEYSWITCH AND KEYBOARD

(76) Inventors: Chao-Lung Chang, Taoyuan (TW); Hsien-Tsan Chang, Taoyuan (TW); Huang-Hsiao Kao, Taoyuan (TW)

(21) Appl. No.: 13/175,963

(22) Filed: Jul. 5, 2011

(30) Foreign Application Priority Data
Jul. 8, 2010 (TW) 099213044

(51) Int. Cl. H01H 13/76; H01H 13/14

(52) U.S. Cl. 200/5 A; 200/344

(57) ABSTRACT

A keyswitch includes a key cap, a base, a circuit board, a film, a resilient member and a pressure sensing member. The circuit board is disposed on the base. The film is disposed on the circuit board. The resilient member is disposed between the film and the key cap. The pressure sensing member is disposed at a position selected from a group consisting of a position between the resilient member and the film, a position between the film and the circuit board, and a position between the circuit board and the base. When the key cap is pressed by an external force, the pressure sensing member senses a magnitude of the external force.

### BACKGROUND OF THE INVENTION

1. Field of the Invention

The invention relates to a keyswitch and a keyboard and, more particularly, to a keyswitch capable of sensing a magnitude of a pressing force.

2. Description of the Prior Art

A keyboard, which is the most common input device, can be found in variety of electronic equipments for users to input characters, symbols, numerals and so on. From consumer electronic products to industrial machine tools are all equipped with a keyboard for purpose of operation.

In general, the conventional keyboard is only used for purpose of input and cannot sense a pressing force generated by a user. Therefore, for example, when the user presses the keyswitch with a large force due to angry, the convention keyboard cannot sense the force generated by the user and then cannot inform the user to relax through a predetermined program installed in a computer. Furthermore, when the user presses the keyswitch with a slight force due to low spirit, the convention keyboard cannot sense the force generated by the user and then cannot inform the user to brace up through the predetermined program installed in the computer either.

### SUMMARY OF THE INVENTION

Therefore, an objective of the invention is to provide a keyswitch capable of sensing a magnitude of a pressing force.

According to an embodiment, a keyswitch of the invention comprises a key cap, a base, a circuit board, a film, a resilient member and a pressure sensing member. The circuit board is disposed on the base. The film is disposed on the circuit board. The resilient member is disposed between the film and the key cap. The pressure sensing member is disposed at a position selected from a group consisting of a position between the resilient member and the film, a position between the film and the circuit board, and a position between the circuit board and the base. When the key cap is pressed by an external force, the pressure sensing member senses a magnitude of the external force.

According to another embodiment, a keyswitch of the invention comprises a key cap, a base, a pressure sensing circuit board and a resilient member. The pressure sensing circuit board is disposed on the base. The resilient member is disposed between the pressure sensing circuit board and the key cap. When the key cap is pressed by an external force, the pressure sensing circuit board senses a magnitude of the external force.

According to another embodiment, a keyswitch of the invention comprises a key cap, a base, a circuit board, a pressure sensing member and a resilient member. The circuit board is disposed on the base. The pressure sensing member is disposed on the circuit board. The resilient member is disposed between the pressure sensing member and the key cap. When the key cap is pressed by an external force, the pressure sensing member senses a magnitude of the external force.

Another objective of the invention is to provide a keyboard, which comprises a base and a plurality of keyswitches disposed on the base. The structure of one of the keyswitches of the keyboard is mentioned in the above.

As mentioned in the above, the invention adds the pressure sensing member into the keyswitch or integrates the pressure sensing member with other components (e.g. circuit board or film), so as to enable the keyswitch to sense a magnitude of a pressing force generated by a user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a keyboard according to a first embodiment of the invention.

FIG. 2 is a cross-sectional view illustrating a keyswitch along line X-X shown in FIG. 1.

FIG. 3 is a cross-sectional view illustrating a keyswitch according to a second embodiment of the invention.

FIG. 4 is a cross-sectional view illustrating a keyswitch according to a third embodiment of the invention.

FIG. 5 is a cross-sectional view illustrating a keyswitch according to a fourth embodiment of the invention.

FIG. 6 is a cross-sectional view illustrating a keyswitch according to a fifth embodiment of the invention.

### DETAILED DESCRIPTION

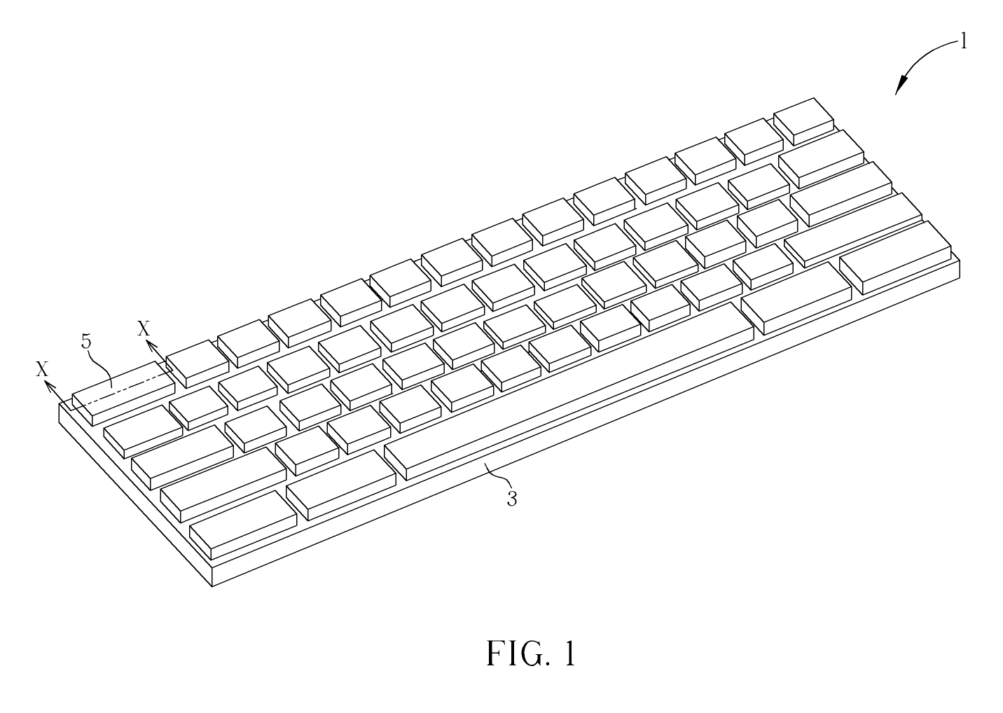

Referring to FIG. 1, FIG. 1 is a schematic diagram illustrating a keyboard 1 according to a first embodiment of the invention. As shown in FIG. 1, the keyboard 1 comprises a base 3 and a plurality of keyswitches 5. The keyswitches 5 are disposed on the base 3 for a user to press, so as to execute desired function correspondingly.

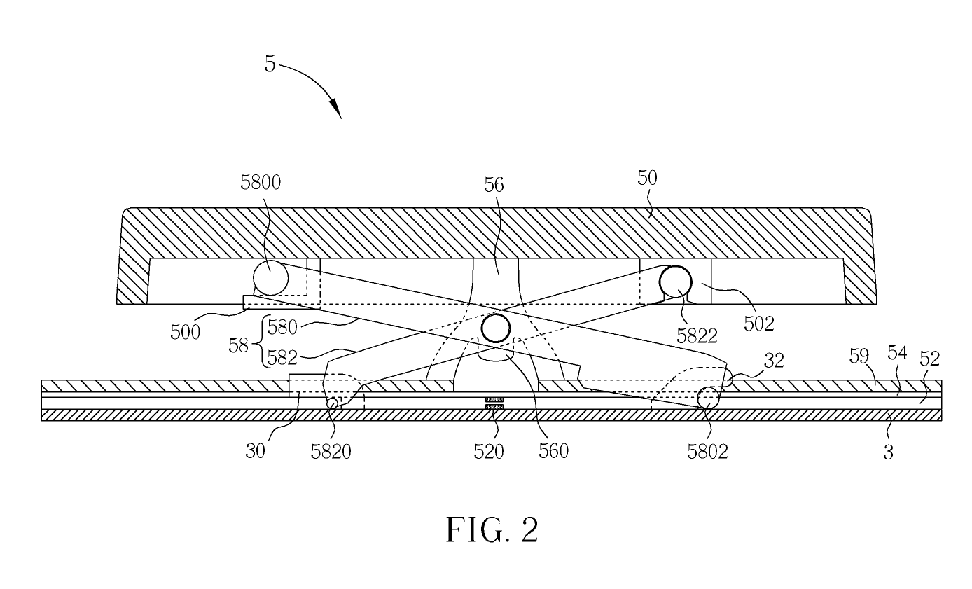

Referring to FIG. 2, FIG. 2 is a cross-sectional view illustrating a keyswitch 5 along line X-X shown in FIG. 1. As shown in FIG. 2, the keyswitch 5 comprises a key cap 50, a base 3, a circuit board 52, a film 54, a resilient member 56, a lift support device 58 and a pressure sensing member 59. The circuit board 52 is disposed on the base 3, the film 54 is disposed on the circuit board 52, and the resilient member 56 is disposed between the film 54 and the key cap 50. In practical applications, the circuit board 52 has a switch 520, such as a membrane switch or other types of switches. The film 54 may be a mylar film or be made of other plastic materials for isolation. The resilient member 56 has a trigger portion 560. The resilient member 56 may be, but not limited to, a rubber dome. The resilient member 56 is used to provide elastic force while the key cap 50 moves upward and downward with respect to the case 3. When the keyswitch 5 is pressed, the trigger portion 560 of the resilient member 56 triggers the switch 520 of the circuit board 52, so as to execute desired function correspondingly.

As shown in FIG. 2, the lift support device 58 is disposed between the key cap 50 and the base 3. The key cap 50 has a first sliding groove 500 and a first engaging groove 502. The base 3 has a second sliding groove 30 and a second engaging groove 32. The lift support device 58 comprises a first support member 580 and a second support member 582, wherein the second support member 582 is pivotally connected to the first support member 580. The first support member 580 has a first sliding portion 5800 and a first pivoting portion 5802, wherein the first sliding portion 5800 is slidably disposed in the first sliding groove 500 and the first pivoting portion 5802 is pivotally disposed in the second engaging groove 32. The second support member 582 has a second sliding portion 5820 and a second pivoting portion 5822, wherein the second sliding portion 5820 is slidably disposed in the second sliding groove 30 and the second pivoting portion 5822 is pivotally disposed in the first engaging groove 502. Accordingly, when the keyswitch 5 is pressed, the key cap 50 will move toward the base 3 along with the lift support device 58.

In this embodiment, the pressure sensing member 59 may be, but not limited to, a strain gage. The pressure sensing member 59 is used to sense the magnitude of a pressing force. As shown in FIG. 2, the pressure sensing member 59 can be disposed between the resilient member 56 and the film 54. When the key cap 50 is pressed by an external force, the resilient member 56 is pressed by the external force at the same time, so that the pressure sensing member 59 senses the magnitude of the external force via the resilient member 56. Accordingly, the keyboard 1 of the invention can sense the magnitude of the external force, which is acted on the keyswitch 5 by a user, by the pressure sensing member 59.

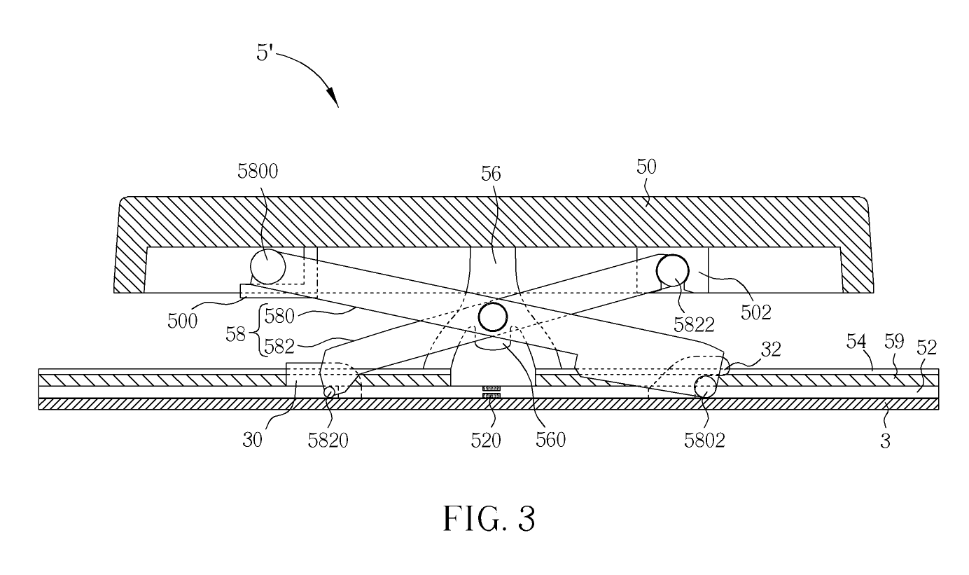

Referring to FIG. 3, FIG. 3 is a cross-sectional view illustrating a keyswitch 5′ according to a second embodiment of the invention. As shown in FIGS. 2 and 3, the main difference between the first and second embodiments is that the pressure sensing member 59 is disposed between the film 54 and the circuit board 52. It should be noted that the principles and structures of the components with identical labels in FIGS. 3 and 2 are substantially the same, so they will not be depicted herein again.

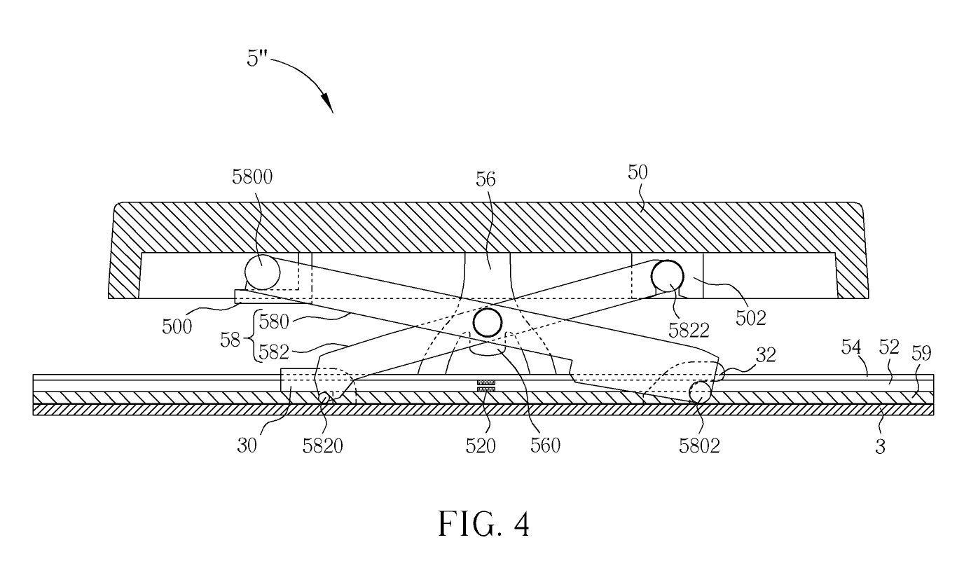

Referring to FIG. 4, FIG. 4 is a cross-sectional view illustrating a keyswitch 5″ according to a third embodiment of the invention. As shown in FIGS. 2 and 4, the main difference between the first and third embodiments is that the pressure sensing member 59 is disposed between the circuit board 52 and the base 3. It should be noted that the principles and structures of the components with identical labels in FIGS. 4 and 2 are substantially the same, so they will not be depicted herein again.

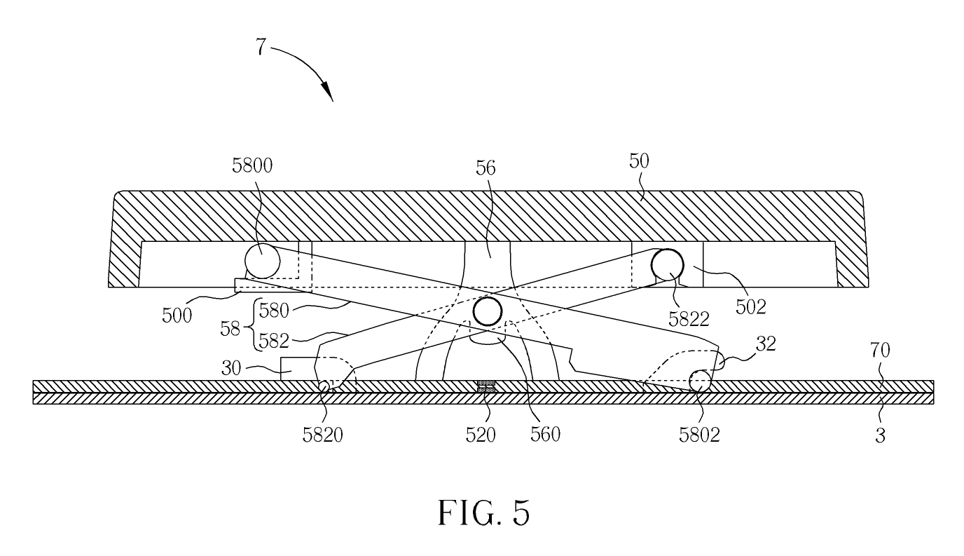

Referring to FIG. 5, FIG. 5 is a cross-sectional view illustrating a keyswitch 7 according to a fourth embodiment of the invention. As shown in FIG. 5, the keyswitch 7 comprises a key cap 50, a base 3, a resilient member 56, a lift support device 58 and a pressure sensing circuit board 70. The pressure sensing circuit board 70 is disposed on the base 3. The resilient member 56 is disposed between the pressure sensing circuit board 70 and the key cap 50. Furthermore, a film (not shown) may be selectively disposed on the pressure sensing circuit board 70 of the keyswitch 7 and the film may be a mylar film or be made of other plastic materials for isolation. The main difference between the first and fourth embodiments is that the pressure sensing circuit board 70 consists of a strain gage and a circuit board. The pressure sensing circuit board 70 is capable of sensing the magnitude of a pressing force and provides a switch relative to the keyswitch 7. For example, when the key cap 50 is pressed by an external force, the resilient member 56 is pressed by the external force at the same time, so that the pressure sensing circuit board 70 senses the magnitude of the external force via the resilient member 56. Accordingly, the invention can sense the magnitude of the external force, which is acted on the keyswitch 7 by a user, by the pressure sensing circuit board 70. It should be noted that the principles and structures of the components with identical labels in FIGS. 5 and 2 are substantially the same, so they will not be depicted herein again.

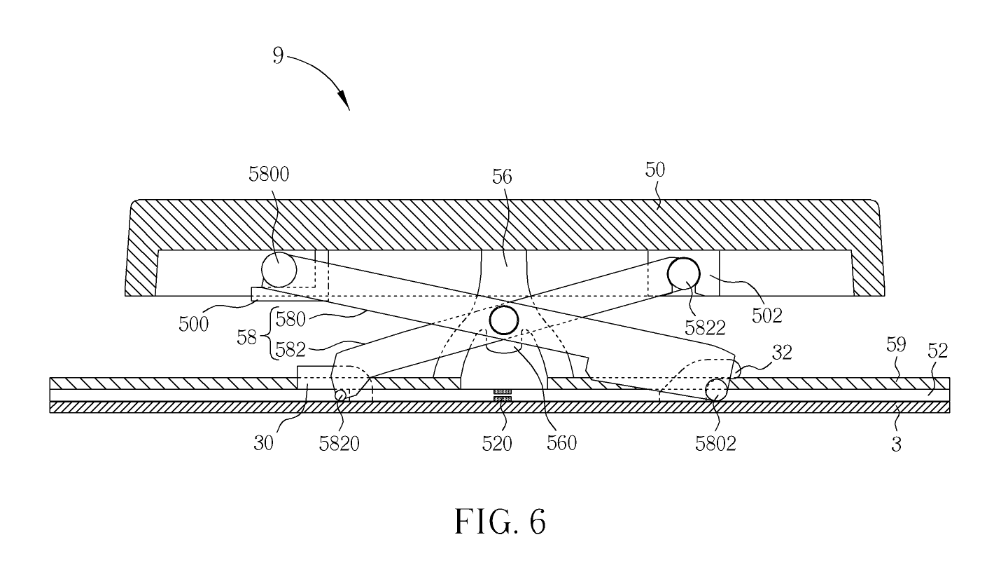

Referring to FIG. 6, FIG. 6 is a cross-sectional view illustrating a keyswitch 9 according to a fifth embodiment of the invention. As shown in FIG. 6, the keyswitch 9 comprises a key cap 50, a base 3, a circuit board 52, a resilient member 56, a lift support device 58 and a pressure sensing member 59. The circuit board 52 is disposed on the base 3. The pressure sensing member 59 is disposed on the circuit board 52. The main difference between the first and fifth embodiments is that the keyswitch 9 does not comprise a film. In this embodiment, the pressure sensing member 59 may be a strain gage covered by an isolated material, such that the pressure sensing member 59 is capable of sensing the magnitude of a pressing force and can be used for isolation. For example, when the key cap 50 is pressed by an external force, the resilient member 56 is pressed by the external force at the same time, so that the pressure sensing member 59 senses the magnitude of the external force via the resilient member 56. Accordingly, the invention can sense the magnitude of the external force, which is acted on the keyswitch 9 by a user, by the pressure sensing member 59. It should be noted that the principles and structures of the components with identical labels in FIGS. 6 and 2 are substantially the same, so they will not be depicted herein again.

As mentioned in the above, the invention adds the pressure sensing member into the keyswitch or integrates the pressure sensing member with other components (e.g. circuit board or film), so as to enable the keyswitch to sense a magnitude of a pressing force generated by a user. For example, after sensing the magnitude of the pressing force generated by the user, a computer may obtain an emotion status of the user and then informs the user of a specific response through a predetermined program installed in the computer. When the user presses the keyswitch with a large force due to angry, the keyboard of the invention may inform the user to relax. Furthermore, when the user presses the keyswitch with a slight force due to low spirit, the keyboard of the invention may inform the user to brace up. It should be noted that the practical applications of the invention are not limited to the aforesaid embodiments.

Those skilled in the art will readily observe that numerous modifications and alterations of the device and method may be made while retaining the teachings of the invention.

What is claimed is:

1. A keyswitch comprising:
a key cap;
a base;
a circuit board disposed on the base;
a film disposed on the circuit board;
a resilient member disposed between the film and the key cap; and
a pressure sensing member disposed at a position selected from a group consisting of a position between the resilient member and the film, a position between the film and the circuit board, and a position between the circuit board and the base;
wherein when the key cap is pressed by an external force, the pressure sensing member senses a magnitude of the external force.

2. The keyswitch of claim 1, wherein the pressure sensing member is a strain gage.

3. The keyswitch of claim 1, wherein the circuit board has a switch, the resilient member has a trigger portion, when the key cap is pressed, the trigger portion triggers the switch.

4. The keyswitch of claim 1, further comprising a lift support device disposed between the key cap and the base.

5. The keyswitch of claim 4, wherein the key cap has a first sliding groove and a first engaging groove, the base has a second sliding groove and a second engaging groove, the lift support device comprises:
a first support member having a first sliding portion and a first pivoting portion, the first sliding portion being slidably disposed in the first sliding groove, the first pivoting portion being pivotally disposed in the second engaging groove; and
a second support member pivotally connected to the first support member, the second support member having a second sliding portion and a second pivoting portion, the second sliding portion being slidably disposed in the second sliding groove, the second pivoting portion being pivotally disposed in the first engaging groove.

6. A keyboard comprising:
a base; and
a plurality of keyswitches disposed on the base, one of the keyswitches comprising:
a key cap;
a circuit board disposed on the base;
a film disposed on the circuit board;
a resilient member disposed between the film and the key cap; and
a pressure sensing member disposed at a position selected from a group consisting of a position between the resilient member and the film, a position between the film and the circuit board, and a position between the circuit board and the base;
wherein when the key cap is pressed by an external force, the pressure sensing member senses a magnitude of the external force.

7. The keyboard of claim 6, wherein the pressure sensing member is a strain gage.

8. The keyboard of claim 6, wherein the circuit board has a switch, the resilient member has a trigger portion, when the key cap is pressed, the trigger portion triggers the switch.

9. The keyboard of claim 6, further comprising a lift support device disposed between the key cap and the base.

10. The keyboard of claim 9, wherein the key cap has a first sliding groove and a first engaging groove, the base has a second sliding groove and a second engaging groove, the lift support device comprises:
a first support member having a first sliding portion and a first pivoting portion, the first sliding portion being slidably disposed in the first sliding groove, the first pivoting portion being pivotally disposed in the second engaging groove; and
a second support member pivotally connected to the first support member, the second support member having a second sliding portion and a second pivoting portion, the second sliding portion being slidably disposed in the second sliding groove, the second pivoting portion being pivotally disposed in the first engaging groove.

11. A keyswitch comprising:
a key cap;
a base;
a pressure sensing circuit board disposed on the base; and
a resilient member disposed between the pressure sensing circuit board and the key cap;
wherein when the key cap is pressed by an external force, the pressure sensing circuit board senses a magnitude of the external force.

12. The keyswitch of claim 11, further comprising a film disposed between the pressure sensing circuit board and the resilient member.

13. The keyswitch of claim 11, wherein the pressure sensing circuit board comprises a strain gage.

14. The keyswitch of claim 11, wherein the pressure sensing circuit board has a switch, the resilient member has a trigger portion, when the key cap is pressed, the trigger portion triggers the switch.

15. The keyswitch of claim 11, further comprising a lift support device disposed between the key cap and the base.

16. The keyswitch of claim 15, wherein the key cap has a first sliding groove and a first engaging groove, the base has a second sliding groove and a second engaging groove, the lift support device comprises:
a first support member having a first sliding portion and a first pivoting portion, the first sliding portion being slidably disposed in the first sliding groove, the first pivoting portion being pivotally disposed in the second engaging groove; and
a second support member pivotally connected to the first support member, the second support member having a second sliding portion and a second pivoting portion, the second sliding portion being slidably disposed in the second sliding groove, the second pivoting portion being pivotally disposed in the first engaging groove.

17. A keyboard comprising:
a base; and
a plurality of keyswitches disposed on the base, one of the keyswitches comprising:
a key cap;
a pressure sensing circuit board disposed on the base; and
a resilient member disposed between the pressure sensing circuit board and the key cap;
wherein when the key cap is pressed by an external force, the pressure sensing circuit board senses a magnitude of the external force.

18. The keyboard of claim 17, further comprising a film disposed between the pressure sensing circuit board and the resilient member.

19. The keyboard of claim 17, wherein the pressure sensing circuit board comprises a strain gage.

20. The keyboard of claim 17, wherein the pressure sensing circuit board has a switch, the resilient member has a trigger portion, when the key cap is pressed, the trigger portion triggers the switch.

21. The keyboard of claim 17, further comprising a lift support device disposed between the key cap and the base.

22. The keyboard of claim 21, wherein the key cap has a first sliding groove and a first engaging groove, the base has a second sliding groove and a second engaging groove, the lift support device comprises:
a first support member having a first sliding portion and a first pivoting portion, the first sliding portion being slidably disposed in the first sliding groove, the first pivoting portion being pivotally disposed in the second engaging groove; and
a second support member pivotally connected to the first support member, the second support member having a second sliding portion and a second pivoting portion, the second sliding portion being slidably disposed in the second sliding groove, the second pivoting portion being pivotally disposed in the first engaging groove.

23. A keyswitch comprising:
a key cap;
a base;
a circuit board disposed on the base;
a pressure sensing member disposed on the circuit board; and
a resilient member disposed between the pressure sensing member and the key cap;
wherein when the key cap is pressed by an external force, the pressure sensing member senses a magnitude of the external force.

24. The keyswitch of claim 23, wherein the pressure sensing member is a strain gage.

25. The keyswitch of claim 23, wherein the circuit board has a switch, the resilient member has a trigger portion, when the key cap is pressed, the trigger portion triggers the switch.

26. The keyswitch of claim 23, further comprising a lift support device disposed between the key cap and the base.

27. The keyswitch of claim 26, wherein the key cap has a first sliding groove and a first engaging groove, the base has a second sliding groove and a second engaging groove, the lift support device comprises:
a first support member having a first sliding portion and a first pivoting portion, the first sliding portion being slidably disposed in the first sliding groove, the first pivoting portion being pivotally disposed in the second engaging groove; and
a second support member pivotally connected to the first support member, the second support member having a second sliding portion and a second pivoting portion, the second sliding portion being slidably disposed in the second sliding groove, the second pivoting portion being pivotally disposed in the first engaging groove.

28. A keyboard comprising:
a base; and
a plurality of keyswitches disposed on the base, one of the keyswitches comprising:
a key cap;
a circuit board disposed on the base;
a pressure sensing member disposed on the circuit board; and
a resilient member disposed between the pressure sensing member and the key cap;
wherein when the key cap is pressed by an external force, the pressure sensing member senses a magnitude of the external force.

29. The keyboard of claim 28, wherein the pressure sensing member is a strain gage.

30. The keyboard of claim. 28, wherein the circuit board has a switch, the resilient member has a trigger portion, when the key cap is pressed, the trigger portion triggers the switch.

31. The keyboard of claim 28, further comprising a lift support device disposed between the key cap and the base.

32. The keyboard of claim 31, wherein the key cap has a first sliding groove and a first engaging groove, the base has a second sliding groove and a second engaging groove, the lift support device comprises:
a first support member having a first sliding portion and a first pivoting portion, the first sliding portion being slidably disposed in the first sliding groove, the first pivoting portion being pivotally disposed in the second engaging groove; and
a second support member pivotally connected to the first support member, the second support member having a second sliding portion and a second pivoting portion, the second sliding portion being slidably disposed in the second sliding groove, the second pivoting portion being pivotally disposed in the first engaging groove.
